(19) United States
(12) Patent Application Publication
(10) Pub. No.: US 2026/0240354 A1
(43) Pub. Date: Aug. 20, 2026

(54) COOKING DEVICE

(71) Applicant: Miele & Cie. KG, Gütersloh (DE)

(72) Inventors: Thomas METZ, Bünde (DE); Ulrike LENZEN, Herford (DE); York STÜTTGEN, Soest (DE)

(21) Appl. No.: 19/161,721

(22) PCT Filed: Feb. 13, 2024
(86) PCT No.: PCT/EP2024/053621

§ 371 Date: Sep. 3, 2025

(30) Foreign Application Priority Data
Mar. 8, 2023 (BE) BE2023/5173

(51) Int. Cl. A47J 27/04; F24C 15/00; F24C 15/32

(52) U.S. Cl. CPC A47J 27/04; F24C 15/003; F24C 15/327; A47J 2027/043

(57) ABSTRACT

A cooking appliance includes: a cooking chamber for receiving at least one cookware item through an access opening; a closure element for closing and clearing the access opening to the cooking chamber; at least one cookware item for receiving food to be cooked; and at least one bottom heating element disposed at a lowest point of the cooking chamber, the at least one bottom heating element evaporating condensed water collecting there. The at least one cookware item has an at least substantially closed base. The at least substantially closed base includes at least one first steam guide element on an underside of the at least substantially closed base facing away from the food to be cooked. The at least one first steam guide element extends vertically away from the underside of the at least substantially closed base when the at least one cookware item is in a normal orientation.

### CROSS-REFERENCE TO PRIOR APPLICATIONS

This application is a U.S. National Phase application under 35 U.S.C. § 371 of International Application No. PCT/EP2024/053621, filed on Feb. 13, 2024, and claims benefit to Belgian Patent Application No. BE 2023/5173, filed on Mar. 8, 2023. The International Application was published in German on Sep. 12, 2024 as WO/2024/184028 under PCT Article 21(2).

### FIELD

The invention relates to a cooking appliance and a cookware item for use in such a cooking appliance.

### BACKGROUND

Various kitchen appliances, which can also be referred to as cooking appliances, are known for the preparation of foodstuffs, which can also be referred to as food to be treated or food to be cooked. These include cooktops on which the item to be cooked can be prepared in a cookware item, for example, in a pot with or without a lid, in a pan, and the like, by cooking, roasting, and the like.

Further, there are known cooking appliances which have a cooking chamber that is configured in immovable (i.e., stationary) relationship with the cooking appliance and in which the item to be cooked can be placed in or on a cookware item and cooked while the cooking chamber of the cooking appliance is closed. A cooking appliance of this type can be, for example, an oven, a steam cooker, a microwave, a combination appliance composed of an oven with a steam cooker or with a microwave, and the like. At least in Germany, such cooking appliances with a stationary cooking chamber typically have an overall height (in the vertical direction) of about 45 cm, but ovens with an overall height of about 60 cm are also common.

A cooking appliance of the aforementioned type is known from patent publication DE 10 2017 111 075 A1. Other similar cooking appliances are disclosed in patent publications EP 0 768 055 A1 and CN 105 042 549 B.

Such cooking appliances with a stationary cooking chamber have in common that they have an outer housing as an outer enclosure that substantially encloses the cooking appliance outwardly, protecting the individual components and elements thereof and allowing them to be handled together. Formed within the cooking appliance is an interior space which constitutes the cooking chamber and is substantially enclosed by an inner housing as an inner enclosure, also referred to as the cooking chamber shell or oven shell. Between the inner enclosure and the outer enclosure, a housing space is formed as an interstitial space in which may be disposed functional elements of the cooking appliance, such as a controller or control unit, an electrical power supply, and other components that serve the intended use of the cooking appliance. As viewed in the depth direction from the front, i.e. from the perspective of a user, the outer enclosure or a front panel in the form of a furniture material or in the form of a control panel and the like, together with the inner enclosure, encloses the housing space so that the housing space is not accessible to the user.

As viewed along the depth, the interior space of the cooking appliance has a front-facing through-opening as an access opening through which the interior space of the cooking appliance is accessible to the user, allowing the user to insert and position cookware items in the interior space of the cooking appliance as its cooking chamber and to take out and remove cookware items from the interior space of the cooking appliance after the treatment of the item to be cooked is complete. The user can open the access opening by means of a closure element, for example, in the form of a side-swinging door, a drop-down door, and the like, in order to gain access to the interior space of the cooking appliance as previously described, or to close the interior space of the cooking appliance and perform the cooking operation or process. Such a closure element may be of a closed design or may have a viewing window to allow the user to look into the closed interior space of the cooking appliance.

A cookware item having a base provided with a rib structure is known from patent publication CN 103 096 765 B. Cookware is also shown in patent publications DE 621 265 C and U.S. Pat. No. 4,676,151 A.

Such cooking appliances with a stationary cooking chamber are typically designed as built-in appliances or built-in kitchen appliances to be fixedly disposed in a space-saving manner with their outer enclosure in kitchen furniture, such as built-in kitchen cabinets, at a vertical height that is easily accessible to the user and such that their closure element and, if present, also their front panel (see above) is/are flush with the surfaces of the other cooking appliances, drawers, doors, and the like, of the kitchen furniture, as viewed looking toward the user, which can improve the visual appearance to the user.

Also known are other built-in kitchen appliances, such as those with warming drawers, vacuum sealing drawers, and the like, which are installed in the kitchen as described hereinbefore and, in particular, combined with the above-described cooking appliances as built-in appliances and arranged horizontally above one another and/or vertically adjacent to one another. Warming drawers are used, for example, to keep the cooked food warm without further cooking and to preheat dishes. In vacuum sealing drawers, food items can be sealed under vacuum in an airtight package.

A warming drawer for cooking food items is shown in patent publications EP 3 508 792 A1 and JP 2017 053 534 A.

Such drawers as kitchen appliances are basically constructed similarly to the previously described cooking appliances with a stationary cooking chamber. However, drawers are significantly flatter, i.e. smaller in the vertical direction, and must therefore be pulled forwardly out of the kitchen furniture unit by the user toward himself/herself in order to allow access to the interior space thereof vertically from above. For this purpose, the movable part of the drawer, which can also be referred to as a pull-out box, has a pull-out box bottom, which serves to receive, for example, the cookware vertically from above and may be configured to be movable in the depth direction relative to the inner enclosure of the drawer, for example via rails arranged in the transverse direction laterally. The pull-out box bottom usually has a vertically oriented front panel in the depth direction toward the front, the front panel closing the interior space of the drawer or its access opening in the closed state.

At least in Germany, such drawers, also called built-in drawers, usually have a height of about 15 cm in the vertical direction. Drawers are usually disposed vertically below a cooking appliance with a stationary cooking chamber, for example, below an oven, below a steam cooker, and the like, or combined and vertically stacked with another drawer, but can also be built individually and independently into a kitchen furniture unit. Since, at least in Germany, the installation spaces for built-in kitchen appliances in kitchen furniture, which can also be referred to as niches, usually have a vertical height of about 60 cm, a drawer having an overall height of about 15 cm and a cooking appliance with a stationary cooking space having an overall height of about 45 cm can, in particular, be modularly combined and used as built-in appliances.

Another built-in appliance in the form of a drawer is disclosed in patent publication DE 10 2021 105 049 A1.

Also known are cooking appliances with a steam cooking function which are configured as built-in drawers and can be referred to as steam cooking drawers. Such steam cooking drawers usually receive at least one cooking container with food to be cooked in their cooking chamber, which is located on the pull-out box bottom. The cooking container is usually removable, typically upwardly out of the open built-in drawer. Accordingly, the access opening to the cooking chamber of steam cooking drawers is horizontal and usually rectangular and can usually be closed and opened by a pivotable lid. The pivotable lid is usually mounted at the rear edge of the steam cooking drawer facing away from the front panel such that it is pivotable upwardly.

One of the cooking methods that can be performed in steam cookers is cooking under vacuum, which is also known as sous vide cooking. In this low-temperature cooking method, the food to be cooked, in particular meat, fish, or vegetables, is sealed in an airtight plastic bag, then the interior of the plastic bag is vacuum-sealed, and, finally, the food sealed airtight without air in the plastic bag is cooked at a relatively low temperature of less than 100° C. in a water bath in a container or, when using a steam cooker or a cooking appliance with a steam cooking function, in the steam of the cooking chamber.

If, for example, a sous vide cooking process is carried out in such a cooking appliance using steam, the cooking process usually takes place at temperatures of 45° C. to 90° C. in the cooking chamber, which usually has a height of 250 mm. In this case, the condensate tray made of, for example, 0.8 mm stainless steel is inserted at the first shelf level (counted from below) and a grate for supporting food is inserted thereabove at the second shelf level. The steam/air mixture in the cooking chamber is uniformly mixed by the hot-air fan.

Such a process of sous vide cooking using steam can take place in such a way that steam is introduced into the cooking chamber through the steam inlets at the beginning of the cooking process. The steam that condenses on the food item or on the plastic bag in which the food item is vacuum-sealed usually drips down and remains in the unperforated cooking container at the first, lower shelf level. The steam that condenses on the cooking chamber walls collects on the bottom of the cooking chamber. To prevent a continuously increasing amount of condensate at the bottom of the cooking chamber, a bottom heating element may be used for evaporation. The bottom heating element may be disposed centrally at the bottom of the cooking chamber.

In this way, steam at a temperature of about 100° C. rises from the bottom heating element during the cooking process and is directed toward the cooking chamber walls by the condensate tray at the first, lower shelf level. As a result of free convection, the steam rises up along the cooking chamber walls, and slightly colder steam sinks in temperature layers down from the ceiling of the cooking chamber. Horizontal isotherms are formed, just like in a layer storage system. The food item is surrounded by a steam/air mixture having a uniform temperature and is thus evenly cooked. The temperature of the steam/air mixture can be measured by a temperature sensor at the level of the food item, and the output of the bottom heating element or of the steam generator can be controlled accordingly by a control unit.

However, such a process of sous vide cooking using steam cannot be applied to a steam cooking drawer, since the cooking chamber of a steam cooking drawer typically has a useful height of 80 mm and therefore lacks the possibility of producing a uniform temperature stratification. In this case, steam rises up along the sides of the condensate tray and is pushed directly toward the food item by the significantly lower ceiling.

In addition, the condensate in the condensate tray accumulates preferably at the center of the condensate tray, where it is evaporated by the rising steam of the bottom heating element through the condensate tray of sheet metal. As a result, a column of steam forms directly above the evaporated condensate, causing the food item in the vacuum-sealed plastic bag to be cooked unevenly.

EP 2 749 190 A1 describes a method of assembling a sous vide cooker in a housing. The method includes providing a chamber having a bottom interior surface, including a circulator, including a heating unit, and arranging one or more temperature sensors exterior to the chamber, implementing a proportional-integral-derivative (PID) controller, and placing a control panel, wherein the PID controller has been programmed with a temperature correction algorithm for converting temperatures measured by the one or more temperature sensors into the actual water temperature in the chamber based on a predetermined formula, and wherein the heating unit heats the chamber and the PID controller controls the heating unit using the one or more temperature sensors and the difference between a preset temperature and the actual water temperature.

EP 2 926 700 A1 describes a sous-vide circulation cooker temperature control device that includes a motor module which can be replaced by users if the motor fails. The circulator cooker temperature control device includes an outer portion, an upper portion, a middle portion, and a lower portion. The upper portion includes a programmable controller storing one or more codes that represent cooking temperatures and times selectable by a user. The controller can be programmed to receive additional codes. The controller includes a speaker and a voice assist algorithm configured to alert users of events.

US 2019/208946 A1 describes a portable sous vide cooking appliance that does not require a motor to move water or has its own container. The portable sous vide cooking appliance may be used with a separate pot or other container for water. The sous vide cooking appliance requires no water circulation to function. Unlike immersion thermostats, only the heating element and the mechanism for delivering power to the heating element are immersed in water. The sous vide cooking appliance described requires no electric motor, no impeller pump, no water inlet, and no water outlet. Further, unlike immersion thermostats, the sous vide cooking appliance passively circulates water through convection currents and does not need to actively agitate the water bath, creating noise and more evaporation and steam.

### SUMMARY

In an embodiment, the present invention provides a cooking appliance, comprising: a cooking chamber configured to receive at least one cookware item through an access opening; a closure element configured to close and clear the access opening to the cooking chamber; at least one cookware item configured to receive food to be cooked; and at least one bottom heating element disposed at a lowest point of the cooking chamber, the at least one bottom heating element being configured to evaporate condensed water collecting there, wherein the at least one cookware item has an at least substantially closed base, wherein the at least substantially closed base comprises at least one first steam guide element on an underside of the at least substantially closed base facing away from the food to be cooked, wherein the at least one first steam guide element extends vertically away from the underside of the at least substantially closed base when the at least one cookware item is in a normal orientation, and wherein the at least one first steam guide element is configured to guide steam that rises from the at least one bottom heating element below the at least one cookware item laterally to an edge of the at least substantially closed base.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a kitchen furniture unit with an inventive cooking appliance in the form of a steam cooking drawer according to a first exemplary embodiment, shown in the retracted position;

FIG. 2 is a view corresponding to FIG. 1, but showing the steam cooking drawer in the extended position;

FIG. 3 is a perspective front view obliquely from above of a cookware item according to the invention;

FIG. 4 is a longitudinal section through the cookware item of FIG. 3;

FIG. 5 is a perspective front view obliquely from below of the cookware item of FIG. 3,

FIG. 6 is an enlarged perspective view of the steam cooking drawer of FIG. 2, shown without cookware;

FIG. 7 is an enlarged perspective view of an inventive steam cooking drawer according to a second exemplary embodiment, shown without cookware; and

FIG. 8 is a view similar to FIG. 6 or FIG. 7, but with the cookware item of FIGS. 3 through 5 inserted.

### DETAILED DESCRIPTION

In an embodiment, the present invention extends the functionality of a steam cooking drawer as a steam cooker with significantly reduced space requirements and improves the functions thereof. An embodiment provides a sous vide cooking with steam cooking drawers. An embodiment achieves a homogeneous, horizontal temperature distribution at the level of the food item in the cooking chamber of the steam cooking drawer. An embodiment provides a simple, space-saving, user-friendly, and/or cost-effective result.

Thus, the invention relates to a cooking appliance, in particular a steam cooking appliance, preferably a steam cooking drawer, having a cooking chamber configured to receive at least one cookware item through an access opening, preferably from above, and having a closure element, preferably a lid, configured for closing and clearing the access opening to the cooking chamber by being pivoted by means of a pivoting element, preferably a hinge, and further having at least one cookware item for receiving food to be cooked.

The cooking appliance is characterized in that the cookware item has an at least substantially, preferably completely, closed base, the base of the cookware item having at least one first steam guide element on its underside facing away from the food to be cooked, which guide element is configured to cause steam that rises below the cookware item to be guided laterally to the edge of the base. The cookware item can be used in particular for cooking under vacuum or sous vide cooking using the cooking appliance, in particular the steam cooking drawer, and can therefore also be referred to as a cookware item for cooking under vacuum or as a sous vide cookware item. Without cookware, the interior space of the cooking appliance can also be referred to as cooking chamber. When the cookware item is located in the interior space of the steam cooking drawer, the interior space of the cookware item can be referred to as the cooking chamber of the cookware item and as the cooking chamber of the cooking appliance, in particular of the steam cooking drawer, since this is where the food steaming process can take place or be carried out.

Such a steam guide element extends vertically away from the underside of the base, when considered relative to the position of use. This achieves good guiding performance.

One aspect is that individual steam guide elements are oriented in transverse direction Y or in longitudinal direction X.

It is also possible that a plurality of steam guide elements may be provided.

One aspect is that some or all of the steam guide elements are oriented parallel to each other.

A preferred alternative provides that at least one steam guide element is oriented in transverse direction Y and at least one other steam guide element is oriented in longitudinal direction X.

The invention is based on the discovery that, as described above, the use of a cookware item in a cooking appliance, in particular in a steam cooking drawer, can influence the distribution or flow of the steam within the interior space of the cooking appliance or steam cooking drawer, which can lead to an uneven cooking effect of the steam when an arbitrary cookware item is used.

In accordance with the invention, therefore, at least the steam rising below the cookware item is guided or directed laterally to the edge of the base by the cookware item, so that the rising steam can reach the cooking chamber above the cookware item preferably from the side or preferably from several different sides, in particular from several, preferably diametrically opposite sides. This can be achieved at least for two sides, but also for more than two sides, in particular for four sides, or for two pairs of, preferably diametrically, opposite sides. This can increase the uniformity with which the rising steam can reach the cooking chamber.

In accordance with an aspect of the invention, the cooking appliance, in particular the steam cooking drawer, has at least one temperature sensor that is disposed on a wall, preferably on the rear wall, preferably centrally in the horizontal, and/or above the center in the vertical direction, and oriented toward the cooking chamber, the underside of the base of the cookware item having at least the first steam guide element, which extends transversely to the temperature sensor. In this case, the steam guide elements can specifically prevent the rising steam from flowing toward the temperature sensor and thus distorting the temperature measurement.

In accordance with a further aspect of the invention, the cooking appliance, in particular the steam cooking drawer, has at least one bottom heating element that is disposed at the lowest point of the cooking chamber, preferably centrally in the horizontal, and configured to evaporate condensed water collecting there. This can allow the condensed water collecting there to be re-evaporated and thus to be reused for the steam cooking process. This can reduce the amount of water required for the steam cooking process.

In accordance with another aspect of the invention, the underside of the base of the cookware item has at least one pair of at least substantially parallel first steam guide elements, the cookware item being positioned in the cooking chamber so as to cause steam that rises from the bottom heating element to be guided laterally to the edge of the base between the first steam guide elements, preferably and transversely to the temperature sensor. The bilateral arrangement of the steam guide elements can improve the guidance of the steam, whereby the rising steam can be more effectively kept way from any existing temperature sensor and, in addition, can in any case be distributed in a more defined way above the cookware item or in the cooking chamber.

In accordance with a further aspect of the invention, the cooking appliance, in particular the steam cooking drawer, has a pair of bottom heating elements, which are disposed at the lowest point of the cooking chamber, preferably centrally in the horizontal, and configured to evaporate condensed water collecting there, the two bottom heating elements being spaced apart in the horizontal, preferably in the transverse direction, and the underside of the base of the cookware item having at least one second steam guide element, which preferably extends centrally in the horizontal and/or along a straight line between the two bottom heating elements. This makes it possible to generate two streams of rising steam, to separate them, and to guide each of them in defined way.

In accordance with another aspect of the invention, the lateral edges of the base of the cookware item, toward which the first steam guide element, preferably and the second guide element, guide(s) the rising steam, enclose the cooking chamber with walls. In other words, the cookware item is formed at least partially, preferably completely, in the shape of a tray, so that the interior of the cookware item forms the cooking chamber, which is formed at the bottom by the base of the cookware item and laterally by the walls extending upward from the edge of the base. This can allow the rising steam to be guided further up and thus past the cooking chamber externally and parallel thereto, so that the rising steam can only reach the cooking chamber at the edge of the wall from the side. This can promote the formation of uniform temperature layers in the cooking chamber.

In accordance with another aspect of the invention, an upper edge of at least one wall, preferably of several walls, particularly preferably of all walls, is spaced in the vertical direction from the top of the cooking chamber, preferably from the underside of the lid, by a distance of from 1 mm to 20 mm, preferably from 5 mm to 10 mm. The correspondingly high wall can thus prevent the rising steam from entering the cooking chamber too early. In addition, the relatively narrow clearance between the wall and the lid can promote the formation of a defined and uniform temperature stratification in the cooking chamber.

In accordance with a further aspect of the invention, the wall of the cookware item facing the temperature sensor has a through-opening through which the temperature sensor can directly detect the temperature within the cooking chamber, the cookware item preferably having two diametrically and symmetrically opposite through-openings. This can facilitate the measurement of the temperature in the cooking chamber, also called the cooking chamber temperature. The increased accuracy of the detected cooking chamber temperature can have a positive effect on the cooking process carried out by the user, and particularly on a cooking process carried out in an automated or automatic manner, in particular on a feedback-controlled cooking process.

The provision of two mirror-symmetrically disposed through-openings can allow the user to place the cookware item in either of two orientations in the interior space of the cooking appliance, in particular of the steam cooking drawer, without having to worry about the orientation of the cookware item.

In accordance with another aspect of the invention, the top side of the base of the cookware item facing the food to be cooked has at least one drain surface, preferably a pair of diametrically opposite drain surfaces, configured for guiding condensed water. Thus, the condensed water can at least be collected within the cooking chamber.

In accordance with a further aspect of the invention, the drain surface, preferably each of the drain surfaces, merges into at least one drain opening configured to allow condensed water to flow out and toward the underside of the cookware item. Thus, the condensed water that has collected in the cooking chamber can be drained out and toward the underside of the cooking chamber, where it may be collected or re-evaporated by at least one bottom heating element as previously described.

One aspect is that the drain opening is formed in the drain surface and/or in the wall of the cookware item.

In accordance with another aspect of the invention, the top side of the base of the cookware item facing the food to be cooked has at least one spacer element configured to receive the food to be cooked, preferably in a sous vide cooking container, at a distance from the top surface of the base. Thus, the food item to be cooked can also be reached by steam from the underside thereof, which can promote the steam cooking process.

In accordance with a further aspect of the invention, the spacer element, preferably a plurality of spacer elements, has/have a height of at least 10 mm, preferably at least 14 mm, relative to the top surface of the base of the cookware item. This can assist or ensure that the food to be cooked can be sufficiently reached by the steam from below to thereby promote the steam cooking process.

In accordance with another aspect of the invention, the top side of the base of the cookware item facing the food to be cooked has a plurality of spacer elements which are spaced apart in the horizontal by a distance equal to at least half the height, preferably three quarters to six quarters of the height, particularly preferably more than twice the height, and/or whose upper end has a width in the horizontal at most equal to the distance, preferably less than one third of the distance, between two immediately adjacent spacer elements. These can be particularly suitable possibilities for implementation.

In accordance with a further aspect of the invention, the cookware item is at least substantially, preferably completely, made of plastic. This allows the heat conduction from below the cookware item to the cooking chamber to be reduced, which can assist in heating the cooking chamber as uniformly as possible.

The invention also relates to a cookware item for use in a cooking appliance, in particular a steam cooking drawer, as previously described. Thus, a cookware item can be provided to implement and use the corresponding aspects, properties, and advantages of the cooking appliance, in particular of the steam cooking drawer, as previously described.

In other words, a temperature sensor may be mounted on the rear cooking chamber wall. A sous vide accessory according to the invention is used. The cooking chamber may have two bottom heating elements that are slightly spaced apart.

Steam guide elements may be mounted under the base of the sous vide accessory, the steam guide elements guiding the steam from the bottom heating element to the left and right. These guide elements prevent the steam from the bottom heating element in a defined manner from flowing rearward toward the temperature sensor and thus distorting the temperature measurement.

The sous vide accessory may be formed with steam guide elements extending to the top on the left and right sides thereof. The top edge of the guide geometry may be spaced from the underside of the cooking chamber lid by a distance of from 1 mm to 20 mm, preferably of from 5 mm to 10 mm. These guide elements prevent the hot steam from the bottom heating element from flowing toward the food item already at the level of the food item. They promote the formation of a uniform temperature stratification in the cooking chamber.

Thus, the sous vide accessory may have flow guide geometries on the underside, which allow a food item to be cooked evenly without an air moving device. The food items are only affected by (free) convection.

At the rear side of the sous vide accessory, a wall extending to the top can be dispensed with, at least in some regions. This avoids large temperature differences between the temperature sensor on the rear cooking chamber wall and the food item. There is, as it were, “visual contact” between the temperature sensor and the food item.

At the front side of the sous vide accessory, a wall extending to the top can also be dispensed with. This has the advantage that the sous vide accessory is symmetrical and can be used in an inverted angular orientation by the user without any loss of functionality.

The bottom heating element under the sous vide accessory can generate steam in two spaced-apart positions. The two positions can be on the left and right in the cooking chamber. The steam from the left evaporator can be directed to the left by a steam guide element of the sous vide accessory. Similarly, the steam from the right evaporator can be directed to the right. Thus, hot steam reaches the food item from two sides. The temperature differences from left to right are smaller than when the steam flows to the food item from one side.

To cause the steam from the evaporator locations to be directed to the left and right in a defined manner, a flow barrier may be mounted on the underside of the sous vide accessory to extend from front to the rear thereof. This eliminates the need to control the two evaporator locations differently.

The condensate that accumulates in the sous vide accessory can be directionally guided over inclined surfaces from the center of the sous vide accessory to the front or rear edges. This prevents the hot steam below the accessory from evaporating the condensate in the accessory. The previously known column of steam is prevented.

The accessory may have openings through which the condensate can flow out and be re-evaporated by the bottom heating element. This extends the cooking times for a given supply of fresh water. The proportion of openings or through-holes of the sous vide accessory relative to the base area may be less than 3%. The holes in the base may be configured such that absolutely no steam can pass through the base to the food item.

The top side of the base of the sous vide accessory may have spacer elements to receive the food item from above and space it apart from the top surface of the base. The height of the spacer elements in the form of, for example, tines, spikes, or “hills,” of the sous vide cookware item relative to the base or valleys may be greater than 10 mm, in particular greater than 14 mm. It is quite possible that up to 20 mm, 30 mm, or even 45 mm may be selected for a favorable flow of steam therethrough.

The distance between the “hills” may be equal to at least half the height, preferably three quarters to six quarters of the height, particularly preferably more than twice the height.

The width of the “hilltop” may be equal to the distance, in particular less than one third of the distance, between immediately adjacent spacers elements or “hills.”

The sous vide accessory may be made of plastic. This minimizes heat conduction from below upward through the sous vide accessory.

By designing the cooking appliance as a drawer and, in particular, through the use of the inventive cookware item, the invention can allow the full functionality of a steam cooker to be implemented in a steam cooking drawer as a steam cooker with a significantly reduced space requirements.

The above figures are viewed in Cartesian coordinates. A longitudinal direction X can also be referred to as depth X or length X. Perpendicular to longitudinal direction X is a transverse direction Y, which can also be referred to as width Y. A vertical direction Z, which can also be referred to as height Z and corresponds to the direction of gravity, is perpendicular to both the longitudinal direction X and the transverse direction Y. Longitudinal direction X and transverse direction Y together define the horizontal X, Y, which can also be referred to as horizontal plane X, Y.

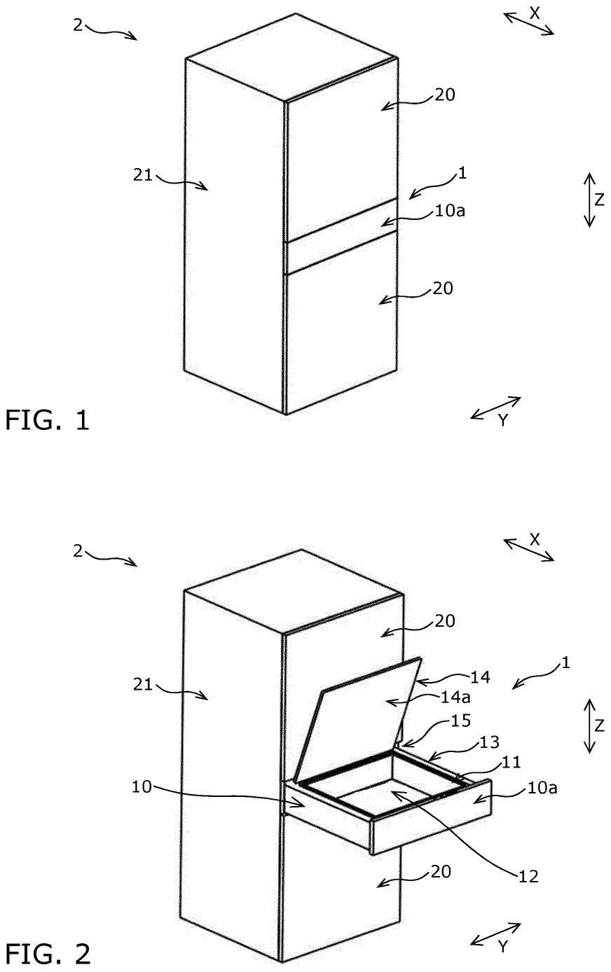

FIG. 1 depicts a perspective view of a kitchen furniture unit 2 with an inventive kitchen appliance in the form of a steam cooking drawer 1 according to a first exemplary embodiment, shown in the retracted position. FIG. 2 shows a view corresponding to FIG. 1, but with steam cooking drawer 1 in the extended position.

Kitchen furniture 2, which can also be referred to as kitchen cabinet run 2, has a furniture front 20 or a plurality of furniture front panels 20 facing a user and forming the front end of kitchen furniture unit 1 in longitudinal direction X. Furniture front 20 is formed by several doors, hinged panels, and the like (not labeled), and possibly drawers, which are pivotably, hingedly, or extendibly mounted on a frame 21, framework 21, or carcass 21 of kitchen furniture unit 2.

A steam cooking drawer 1 according to the invention is disposed approximately centrally along vertical direction Z between two furniture fronts 20. Steam cooking drawer 1 has an outer enclosure 10, which can also be referred to as outer housing 10 and substantially delimits or encloses steam cooking drawer 1 outwardly. Outer enclosure 10 terminates along longitudinal direction X toward the front, i.e., toward the user, with a front panel 10a, which is flush with furniture fronts 20 of kitchen furniture unit 2 when steam cooking drawer 1 is in the retracted position (see FIG. 1). A pair of telescopic rails is mounted on outer enclosure 10 laterally in transverse direction Y, so that steam cooking drawer 1 can be extended and retracted in longitudinal direction X relative to frame 20 of the kitchen furniture unit 2.

Disposed within outer enclosure 10 is an inner enclosure 11, which can also be referred to as inner housing 11. Inner enclosure 11 terminates with outer enclosure 10 rearwardly and forwardly up to front panel 10a in longitudinal direction X, downwardly in vertical direction Z, and at both sides in transverse direction Y, so that an interstitial space is formed between outer enclosure 10 and in inner enclosure 11, which can also be referred to as housing space. This interstitial space represents the interior of steam cooking drawer 1.

Furthermore, inner enclosure 11 substantially encloses an interior space 12, in which a cooking process or a steam cooking process can be carried out. For this purpose, a steam generator is disposed in the housing space or interstitial space of steam cooking drawer 1, the steam generator being capable of evaporating water into steam and conveying the steam into interior space 12. The water can be provided by a removable water tank 19 (see FIGS. 6 through 8). Accordingly, interior space 12 can also be referred to as cooking chamber 12.

Interior space 12 is accessible to the user in vertical direction Z from above through an access opening 13. Access opening 13 can be closed and opened by means of a closure element 14 in the form of a lid 14. For this purpose, lid 14 is attached to outer enclosure 10 of steam cooking drawer 1 by means of at least one pivoting element 15 in the form of a hinge 15 or a lid hinge 15 such that it can be pivoted upward in vertical direction Z, so that the user can pivot lid 14 upward away from himself/herself and toward the furniture front 20 located thereabove in order to be able to access cooking chamber 12 when steam cooking drawer 1 is in the extended position, see FIG. 2. When lid 14 is pivoted down into horizontal X, Y, cooking chamber 12 is closed and steam cooking drawer 1 can be pushed into kitchen furniture unit 2, see FIG. 1. An underside 14a or inner side 14a of lid 14 faces cooking chamber 12.

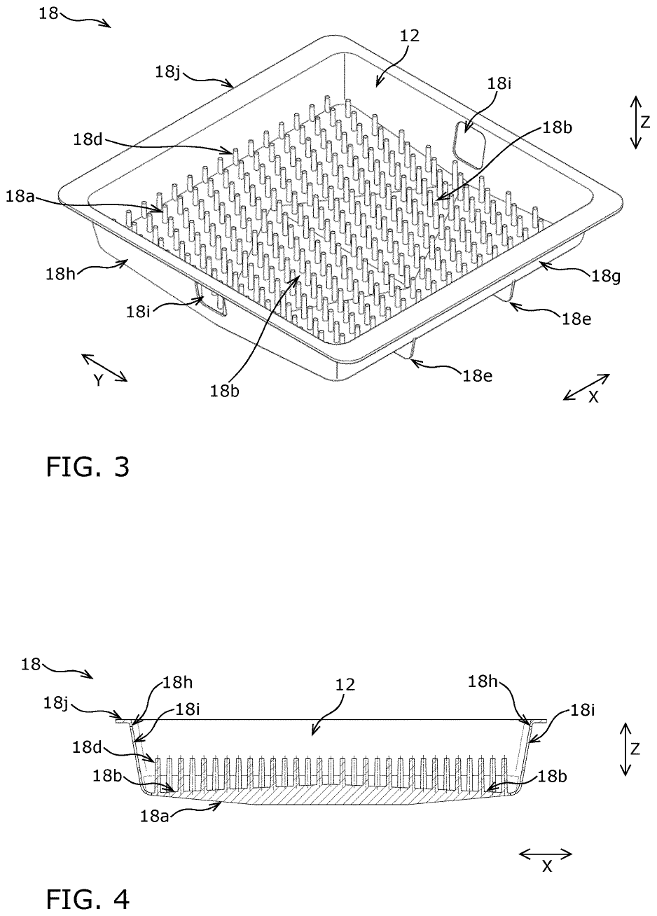

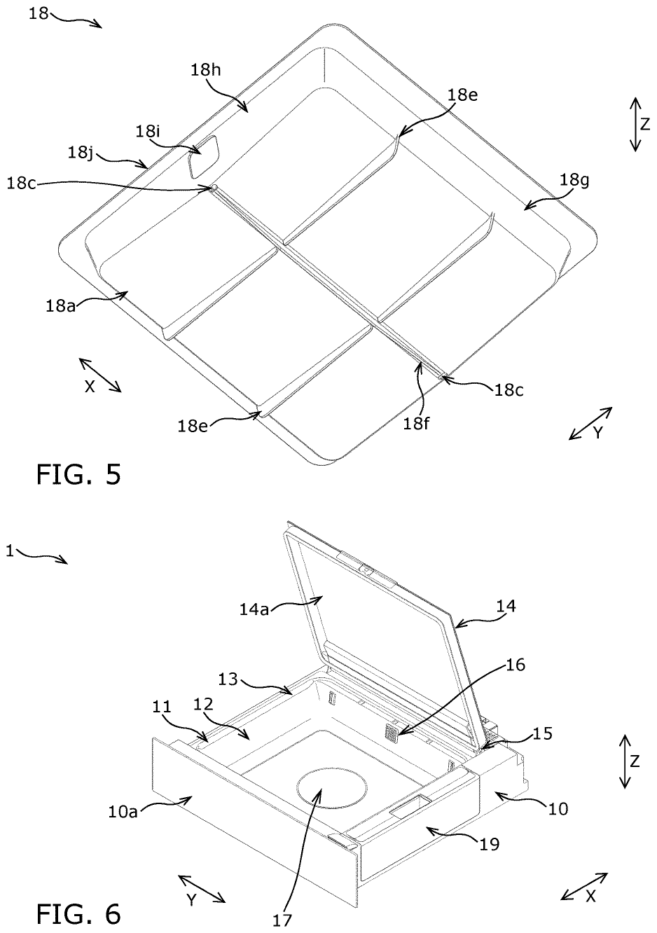

FIG. 3 shows an inventive cookware item 18 in a perspective front view obliquely from above. FIG. 4 shows a longitudinal section through the cookware item 18 of FIG. 3. FIG. 5 shows the cookware item 18 of FIG. 3 in a perspective front view obliquely from below.

The inventive cookware item 18 can also be referred to as sous vide cookware item 18, as sous vide accessory 18, as cooking container 18, or as cooking dish 18. Cookware item 18 is formed as one piece from plastic. Cookware item 18 has a substantially horizontally extending base 18a. The top side (not labeled) of base 18a of cookware item 18 is configured to slope toward two drain openings 18c. To this end, the top side of base 18a is inclined downwardly toward the middle in transverse direction Y, and a crest (not labeled) is formed by the top side of base 18a centrally in longitudinal direction X, from which crest the top side of base 18a slopes triangularly downwardly toward the rear and front (see, for example, FIGS. 3 and 4). One of the two drain openings 18c is provided at each of the two lowest points. Accordingly, condensed water can be collected on the top side of base 18a and drained via drain surfaces 18b or inclined surface 18b toward the two drain openings 18c (see, for example, FIG. 5), where it flows out and toward the underside of cookware item 18.

Spacer elements 18d in the form of, for example, tines 18d, spikes 18d, or hills 18d project from the top side of base 18a upward in vertical direction Z and parallel to one another (see, for example, FIGS. 3 and 4) so that a food item to be cooked can be placed on the tips of spacer elements 18d, either directly or within a sous vide cooking container, for example, within a suitable plastic bag, and reached by the steam from below during the cooking process.

At the underside (not labeled), base 18a has a pair of first steam guide elements 18e oriented in transverse direction Y and projecting vertically downward from the underside of base 18a as elongated projections or edges (see, for example, FIG. 5). Thus, the central area of the underside of base 18a in longitudinal direction X forms a channel that is laterally open in transverse direction Y in order to cause steam that rises up below base 18a of cooking item 18 in the central area in longitudinal direction X to be guided toward both sides in transverse direction Y. The first steam guide elements 18e can therefore also be referred to as transverse steam guide elements 18e.

Also disposed on the underside of base 18a is second steam guide element 18f, which also projects vertically downward from the underside of base 18a as a projection or edge (see, for example, FIG. 5). Second steam guide element 18f extends in longitudinal direction X between the two drain openings 18c and is disposed centrally in transverse direction Y, so that second steam guide element 18f can also be referred to as a longitudinal steam guide element 18f.

Four walls 18g, 18h extend from the edge (not labeled) of base 18a of cookware item 18 upward in vertical direction Z to the same height, where they terminate with a common top edge 18j configured to be horizontally planar. Top edge 18j of cookware item 18 is spaced a relatively small distance form underside 14a of lid 14, so that steam rising up past the walls 18g, 18h at the sides can flow through this relatively small clearance into cooking chamber 12 from above and as uniformly as possible. The walls 18g, 18h can be referred to or distinguished, in transverse direction Y, as side walls 18g or also as lateral steam guide elements 18g and, in longitudinal direction X, between front-side/rear-side walls 18h.

Front-side wall 18h and rear-side wall 18h, which are configured mirror-symmetrically, each have a through-opening 18i in the form of an approximately square window that connects the interior space (not labeled) of cookware item 18 as a cooking space 12 to the ambient environment of cookware item 18.

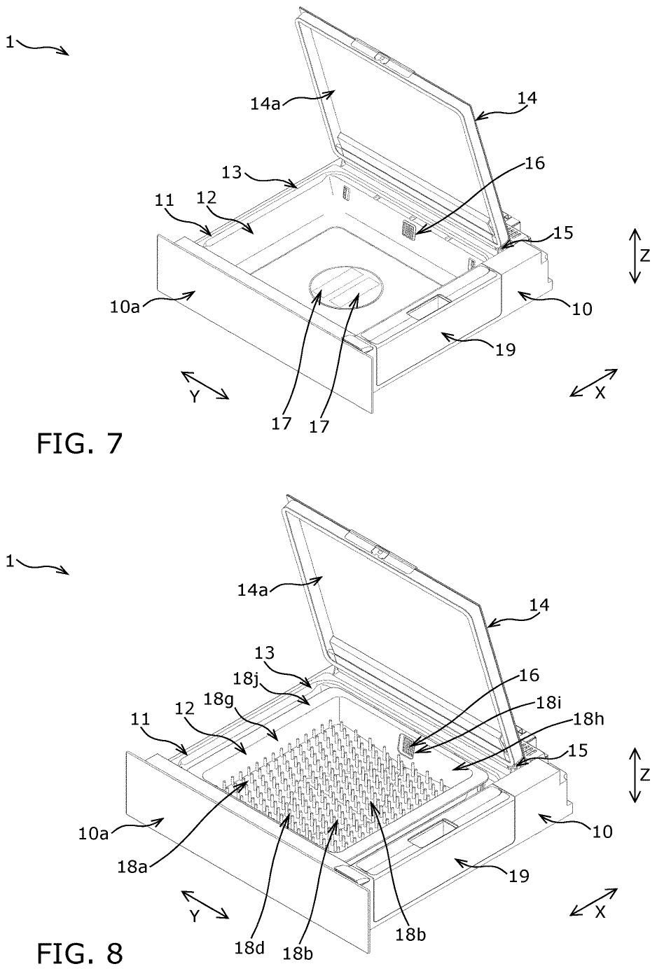

FIG. 6 depicts an enlarged perspective view of the steam cooking drawer 1 of FIG. 2, shown without cookware item 18. FIG. 8 shows a view similar to FIG. 6 or FIG. 7, but with the cookware item 18 of FIGS. 3 through 5 inserted. At the rear side (not labeled) of interior space 12 of steam cooking drawer 1, a temperature sensor 16 is disposed centrally in transverse direction Y and above the center in vertical direction Z and oriented to point into interior space 12 of steam cooking drawer 1 so as to detect the temperature of a steam cooking process therein. The two through-openings 18i of front-side/rear-side walls 18h of cookware item 18 are correspondingly disposed relative to temperature sensor 16, so that temperature sensor 16 can detect the temperature in cooking chamber 12 within cookware item 18 directly through the respective through-opening 18i.

Disposed at the lowest point of interior space 12 of steam cooking drawer 1 is a bottom heating element 17, which can also be referred to as evaporator location 17. Condensed water collecting at the base (not labeled) of inner chamber 12 of steam cooking drawer 1 can be re-evaporated by bottom heating element 17 and thus recycled into the steam cooking process. The condensed water that is evaporated by bottom heating element 17; i.e., the steam rising up therefrom is guided by the pair of first steam guide elements 18e laterally in transverse direction Y and thus also prevented from rising up directly in front of and along temperature sensor 16, which could distort the sensor-based temperature measurement.

FIG. 7 depicts an enlarged perspective view of an inventive steam cooking drawer 1 according to a second exemplary embodiment, shown without cookware item 18. In this case, bottom heating element 17 or evaporator location 17 is configured as a pair of bottom heating elements 17 or evaporator locations 17 which are spaced apart in transverse direction Y. Accordingly, the rising steam can be divided by second steam guide element 18f in the transverse direction and guided to only one side of cookware item 18 per bottom heating 17 or evaporator location 17.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

X longitudinal direction; depth; length
Y transverse direction; width
Z vertical direction; height
X, Y horizontal; horizontal plane
1 steam cooking drawer
10 outer enclosure; outer housing
10a front panel
11 inner enclosure; inner housing
12 interior space; cooking chamber
13 access opening
14 closure element; lid
14a underside or inner side of closure element 14
15 pivoting element; hinge; lid hinge
16 temperature sensor
17 bottom heating element; evaporator locations
18 cookware item; sous vide cookware item; sous vide accessory; cooking container; cooking dish
18a base
18b drain surfaces; inclined surface
18c drain openings
18d spacer elements; tines; spikes; hills
18e first steam guide elements; transverse steam guide elements
18f second steam guide element; longitudinal steam guide element
18g walls; side walls; lateral steam guide elements
18h walls; front-side/rear-side walls
18i through-opening of front-side/rear-side walls 18h
18j top edge of side walls 18g and/or front-side/rear-side walls 18h
19 water tank
2 kitchen furniture unit; kitchen cabinet run
20 furniture front; furniture front panel
21 frame; framework; carcass

1: A cooking appliance, comprising:
a cooking chamber configured to receive at least one cookware item through an access opening;
a closure element configured to close and clear the access opening to the cooking chamber;
at least one cookware item configured to receive food to be cooked; and
at least one bottom heating element disposed at a lowest point of the cooking chamber, the at least one bottom heating element being configured to
evaporate condensed water collecting there,
wherein
the at least one cookware item has an at least substantially closed base,
wherein the at least substantially closed base comprises at least one first steam guide element on an underside of the at least substantially closed base facing away from the food to be cooked,
wherein the at least one first steam guide element extends vertically away from the underside of the at least substantially closed base when the at least one cookware item is in a normal orientation of use, and
wherein the at least one first steam guide element is configured to guide steam that rises from the at least one bottom heating element below the at least one cookware item laterally to an edge of the at least substantially closed base.

2: The cooking appliance of claim 1, further comprising:
at least one temperature sensor disposed on a wall and oriented toward the cooking chamber so as to detect a temperature in the at least one cookware item,
wherein the underside of the at least substantially closed base of the at least one cookware item comprises at least the at least one first steam guide element, which extends transversely to the at least one temperature sensor.

3: The cooking appliance of claim 2,
wherein the underside the at least substantially closed base of the at least one cookware item has at least one pair of at least substantially parallel first steam guide elements,
the at least one cookware item being positioned in the cooking chamber so as to cause steam that rises from the at least one bottom heating element to be guided laterally to the edge of the at least substantially closed base between the at least one pair of at least substantially parallel first steam guide elements.

4: The cooking appliance, of claim 1, wherein the at least one bottom heating element comprises
a pair of bottom heating elements disposed at the lowest point of the cooking chamber, the pair of bottom heating elements being configured to evaporate condensed water collecting at the lowest point of the cooking chamber,
wherein two bottom heating elements of the pair of bottom heating elements are spaced apart in a horizontal direction, and
wherein the underside of the at least substantially closed base of the at least one cookware item has the at least one second steam guide element.

5: The cooking appliance of claim 1,
wherein lateral edges of the at least substantially closed base of the at least one cookware item, toward which the at least one first steam-guide element guides rising steam, enclose the cooking chamber with walls.

6: The cooking appliance of claim 5,
wherein an upper edge of at least one wall of the walls is spaced in a vertical direction from a top of the cooking chamber by a distance of from 1 mm to 20 mm.

7: The cooking appliance of claim 1,
wherein a wall of the at least one cookware item facing the at least one temperature sensor has a through-opening through which the at least one temperature sensor is configured to directly detect a temperature within the cooking chamber when the at least one cookware item is located in the cooking chamber.

8: The cooking appliance of claim 7,
wherein the at least one cookware item has two diametrically and symmetrically opposite through-openings.

9: The cooking appliance of claim 1,
wherein a top side of the at least substantially closed base of the at least one cookware item facing the food to be cooked has at least one drain surface configured to guide condensed water in the at least one cookware item toward at least one wall of the at least one cookware item.

10: The cooking appliance of claim 9,
wherein the at least one drain surface merges into at least one drain opening configured to allow condensed water to flow out and toward the underside of the at least one cookware item.

11: The cooking appliance of claim 1,
wherein a top side of the at least substantially closed base of the at least one cookware item facing the cooking chamber has at least one spacer element at a distance from a top surface of the at least substantially closed base.

12: The cooking appliance of claim 11,
wherein the at least one spacer element has a height of at least 10 mm relative to the top surface of the at least substantially closed base of the at least one cookware item.

13: The cooking appliance of claim 1,
wherein a top side of the at least substantially closed base of the at least one cookware item facing the cooking chamber has comprises a plurality of spacer elements
spaced apart in a horizontal direction by a distance equal to at least half a height,
and/or
wherein an upper end of the at least substantially closed base has a width in the horizontal direction at most equal to a distance between two immediately adjacent spacer elements of the plurality of spacer elements.

14: The cooking appliance of claim 1,
wherein the at least one cookware item comprises plastic.

15: A cookware item for use in the cooking appliance of claim 1.

16: The cooking appliance of claim 1, wherein the cooking appliance comprises a steam cooking drawer.

17: The cooking appliance of claim 1, wherein the cooking chamber configured to receive the at least one cookware item through an access opening from above.

18: The cooking appliance of claim 1, wherein the closure element comprises a lid.

19: The cooking appliance of claim 1, wherein the closure element is configured to close and clear the access opening to the cooking chamber by being pivoted by a pivoting element.

20: The cooking appliance of claim 1, wherein the pivoting element comprises a hinge.
